(19) United States
(12) Patent Application Publication
(10) Pub. No.: US 2024/0386391 A1
(43) Pub. Date: Nov. 21, 2024

(54) PITTING CORROSION PROPAGATION DEGREE MANAGEMENT SYSTEM FOR ROTOR DOVETAIL OF STEAM TURBINE

(71) Applicant: TOSHIBA ENERGY SYSTEMS & SOLUTIONS CORPORATION, Kawasaki-shi (JP)

(72) Inventors: Yasuteru Kawai, Yokohama Kanagawa (JP); Kazuhiro Saito, Yokohama Kanagawa (JP); Yoshikazu Ninomiya, Nerima Tokyo (JP); Yuka Tsukada, Yokohama Kanagawa (JP); Tetsuya Makino, Kawasaki Kanagawa (JP); Osamu Tanaka, Yokohama Kanagawa (JP); Tsukasa Takeuchi, Yokohama Kanagawa (JP); Hiroyuki Ichikawa, Koganei Tokyo (JP); Yasunori Ono, Yokohama Kanagawa (JP)

(73) Assignee: TOSHIBA ENERGY SYSTEMS & SOLUTIONS CORPORATION, Kawasaki-shi (JP)

(21) Appl. No.: 18/404,450

(22) Filed: Jan. 4, 2024

(30) Foreign Application Priority Data
May 17, 2023 (JP) 2023-081448

(51) Int. Cl. G06Q 10/20; F01D 25/00

(52) U.S. Cl. CPC G06Q 10/20; F01D 25/007; F05D 2230/72; F05D 2260/95

(57) ABSTRACT

According to an embodiment, a pitting corrosion propagation degree management system for a rotor dovetail in a rotor of a steam turbine for implanting a rotor blade of the steam turbine, the system comprises a display information generator configured to generate display information for displaying: past pitting corrosion propagation degree related information indicating information on a past pitting corrosion propagation degree of the rotor from the past to the present calculated based on measured information; and future pitting corrosion propagation degree related information indicating information on a future pitting corrosion propagation degree of the rotor dovetail calculated based on a future operation plan input through an input screen of a user interface and the past pitting corrosion propagation degree related information.

This application is based upon and claims the benefit of priority from Japanese Patent Application No. 2023-081448 filed on May 17, 2023, the entire content of which is incorporated herein by reference.

### FIELD

Embodiments of the present invention relate to a pitting corrosion propagation degree management system for a rotor dovetail of a steam turbine.

### BACKGROUND

Recently, in a power plant, an introduction of renewable energy is being accelerated as a measure for reducing carbon dioxide (CO₂) emission. In power generation utilizing the renewable energy, a power generation amount changes according to weather and the like. For this reason, recently, in order to make up for the unstable power supply in the power generation utilizing the renewable energy, an operation of a thermal power plant shifts to an operation in which thermal power generation for adjustment is mainly performed as an adjustment power source.

When the operation is shifted to one as the adjustment power source, the number of times of start-up, stop, and load change tend to increase. As a result of this, latter half stages of a low-pressure turbine are subjected to a wet region and a dry region repeatedly, and thus it has been known that hole-shaped pitting corrosion due to corrosion occurred at a rotor blade implanting part (also referred to as “dovetail”) in a rotor of the low-pressure turbine occurs more frequently than before. When the above operation that is severe for the low-pressure turbine is repeated, the pitting corrosion at the rotor blade implanting part propagates, resulting in that an occurrence risk of SCC (Stress Corrosion Cracking) and CF (Corrosion Fatigue) of the rotor blade implanting part increases.

For an examination of the SCC (stress corrosion cracking) and the CF (corrosion fatigue) due to the pitting corrosion propagation, an inspection of an implanting part has been conventionally performed by lifting a turbine rotor out of the facility and pulling out a blade. However, abnormality may not be observed depending on an operation plan, and in that case, for a generator, time and cost are unnecessarily consumed in a periodic inspection. Accordingly, the generator wants to know at least if it is necessary to perform an inspection of an actual machine.

### BRIEF DESCRIPTION OF THE DRAWINGS

FIG. 1 is a system diagram schematically illustrating a configuration of a steam turbine including a pitting corrosion propagation degree management system according to a first embodiment.

FIG. 2 is a block diagram illustrating a functional configuration of the pitting corrosion propagation degree management system according to the first embodiment.

FIG. 3 is a diagram illustrating one example of an input screen of a future operation plan to be displayed on a user interface in the pitting corrosion propagation degree management system according to the first embodiment.

FIG. 4 is a flow chart illustrating a procedure of fixed cycle calculation processing of pitting corrosion propagation performed by the pitting corrosion propagation degree management system according to the first embodiment.

FIG. 5 is a flow chart illustrating a procedure of future prediction processing of pitting corrosion propagation performed by the pitting corrosion propagation degree management system according to the first embodiment.

FIG. 6 is a diagram illustrating one example of results of a fixed cycle calculation and a future prediction calculation of evaluation parts of a low-pressure turbine to be displayed on the user interface in the pitting corrosion propagation degree management system according to the first embodiment.

FIG. 7 is a diagram illustrating one example of water quality data to be displayed on the user interface in the pitting corrosion propagation degree management system according to the first embodiment.

FIG. 8 is a flow chart for explaining a basic information initial setting step in the pitting corrosion propagation degree management system according to the first embodiment.

FIG. 9 is a flow chart for explaining a fixed cycle calculation step in the pitting corrosion propagation degree management system according to the first embodiment.

FIG. 10 is a flow chart for explaining a future prediction calculation step in the pitting corrosion propagation degree management system according to the first embodiment.

FIG. 11 is a flow chart for explaining future prediction processing in a pitting corrosion propagation degree management system according to a second embodiment.

FIG. 12 is a flow chart for explaining the future prediction processing in the pitting corrosion propagation degree management system according to the second embodiment.

FIG. 13 is a diagram illustrating one example of a display screen in the pitting corrosion propagation degree management system according to the second embodiment.

FIG. 14 is a diagram illustrating one example of a selection screen for selecting a reference calculation result to be displayed on the user interface in the pitting corrosion propagation degree management system according to the second embodiment.

### DETAILED DESCRIPTION

A problem to be solved by the present invention is to provide a pitting corrosion propagation degree management system for a rotor of a steam turbine with which it is possible to recognize, in chronological order, propagation of pitting corrosion that occurs at a rotor blade implanting part in the rotor of the steam turbine from the past to the present predicted based on operation data, and propagation of future pitting corrosion predicted based on a future operation plan.

According to an aspect of the present invention, there is provided a pitting corrosion propagation degree management system for a rotor dovetail in a rotor of a steam turbine for implanting a rotor blade of the steam turbine, the system comprising a display information generator configured to generate display information for displaying: past pitting corrosion propagation degree related information indicating information on a past pitting corrosion propagation degree of the rotor from the past to the present calculated based on measured information; and future pitting corrosion propagation degree related information indicating information on a future pitting corrosion propagation degree of the rotor dovetail calculated based on a future operation plan input through an input screen of a user interface and the past pitting corrosion propagation degree related information.

Hereinafter, a pitting corrosion propagation degree management system for a rotor dovetail of a steam turbine (referred to as “pitting corrosion propagation degree management system”, hereinafter) according to an embodiment of the present invention will be explained with reference to the drawings. Here, mutually the same or similar parts will be denoted by common reference numerals, and an overlapped explanation will be omitted.

### First Embodiment

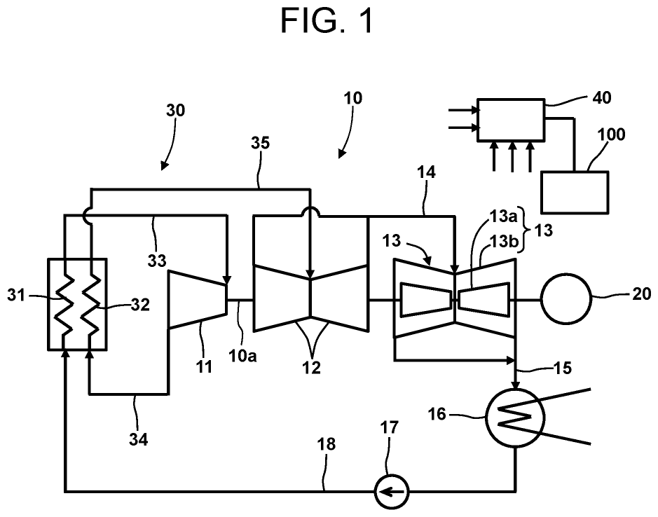

FIG. 1 is a system diagram schematically illustrating a configuration of a power plant 1 including a steam turbine 10 provided with a pitting corrosion propagation degree management system 100 according to the first embodiment.

The power plant 1 includes the steam turbine 10, a generator 20, and a hot source apparatus 30. Here, the hot source apparatus 30 includes a boiler 31 and a reheater 32.

As illustrated in FIG. 1, the steam turbine 10 includes a high-pressure turbine 11, an intermediate-pressure turbine 12, a low-pressure turbine 13, a condenser 16, a feed water pump 17, and the pitting corrosion propagation degree management system 100. The low-pressure turbine 13 includes a low-pressure turbine rotating part 13a and a low-pressure casing 13b. Here, the low-pressure turbine rotating part 13a is a rotor shaft in which a plurality of rotor blades (moving buckets) are implanted. Note that hereinafter, the description of rotor is set to indicate a rotating part or the low-pressure turbine rotating part 13a in particular.

The boiler 31 heats water fed from the steam turbine 10 side to generate steam. The steam generated in the boiler 31 is introduced into the high-pressure turbine 11 through a main steam pipe 33. The high-pressure turbine 11 converts thermal energy of the steam introduced through the main steam pipe 33 into rotational energy, and discharges the steam after performing work in the high-pressure turbine 11 to a cold reheat pipe 34. The steam discharged to the cold reheat pipe 34 is introduced into the reheater 32. The reheater 32 reheats the introduced steam, and leads out the reheated steam to a hot reheat pipe 35.

The intermediate-pressure turbine 12 converts thermal energy of the steam introduced through the hot reheat pipe 35 into rotational energy, and discharges the steam after performing work in the intermediate-pressure turbine 12 to a crossover pipe 14. The low-pressure turbine 13 converts thermal energy of the steam introduced through the crossover pipe 14 into rotational energy of the low-pressure turbine rotating part 13a and the like, and discharges the steam after performing work in the low-pressure turbine 13 to an exhaust hood 15. The generator 20 is driven by the high-pressure turbine 11, the intermediate-pressure turbine 12, and the low-pressure turbine 13, to thereby convert the rotational energy into electric energy to perform power generation.

The condenser 16 condenses the steam introduced through the exhaust hood 15 to produce condensed water. The feed water pump 17 feeds the condensed water produced by the condenser 16 to the boiler 31 as feed water through a feed water pipe 18.

The pitting corrosion propagation degree management system 100 is a system for managing soundness regarding the pitting corrosion propagation in the steam turbine 10. Respective state quantities related to the steam turbine 10 are measured by not-illustrated respective detectors, and signals thereof are taken into an on-site control apparatus 40 such as DCS (Distributed Control System), for example. The pitting corrosion propagation degree management system 100 acquires measurement data required for the pitting corrosion propagation degree management from the on-site control apparatus 40. Note that details of the pitting corrosion propagation degree management system 100 will be described later.

The pitting corrosion propagation degree management system 100 is a system for managing the propagation of pitting corrosion (pitting corrosion propagation) at a rotor blade implanting part in a rotor shaft of the steam turbine 10. The rotor blade implanting part in a rotor shaft will be referred to as “rotor dovetail” hereinafter.

Here, a relevant part of the steam turbine 10 targeted by the pitting corrosion propagation degree management system 100 in this first embodiment, is a rotor dovetail that is subjected to dry steam and wet steam in an alternate manner due to a load change of a unit during operation. Hereinbelow, an explanation will be made by citing a case, as an example, in which a first stage dovetail to a third stage dovetail on an upstream side relative to a final stage of the low-pressure turbine 13 are set as management targets. Here, the dovetail of the low-pressure turbine 13 corresponds to a blade groove (bucket groove) formed on a disk of the rotor shaft for implanting the rotor blade, in the low-pressure turbine rotating part 13a.

Hereinafter, from the first stage dovetail to the third dovetail on the upstream side relative to the final stage of the low-pressure turbine 13, will be referred to as L1 dovetail to L3 dovetail, respectively. Note that L1 dovetail to L3 dovetail are only examples, and the number of stages may be the above or more, or less than the above.

### Configuration of Pitting Corrosion Propagation Degree Management System

Next, the pitting corrosion propagation degree management system 100 will be explained.

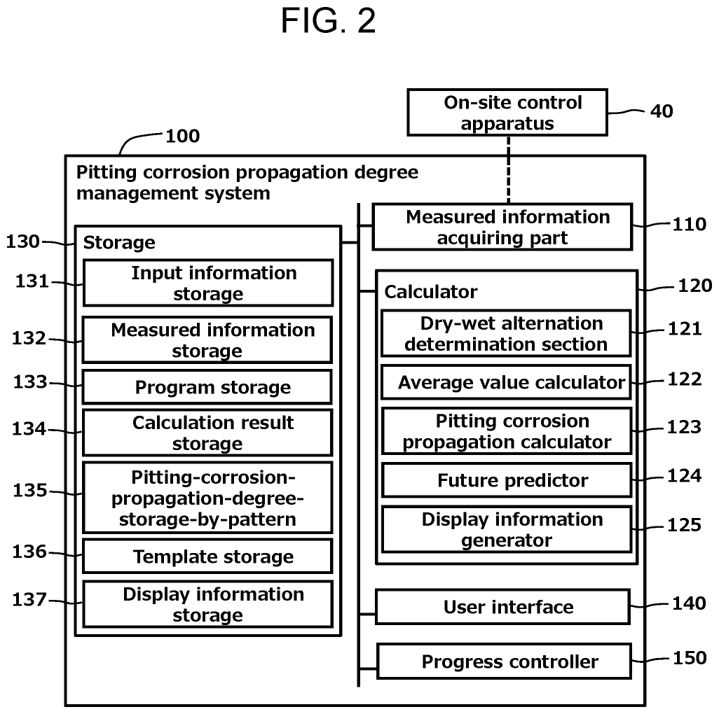

FIG. 2 is a block diagram illustrating a functional configuration of the pitting corrosion propagation degree management system 100 according to the first embodiment.

The pitting corrosion propagation degree management system 100 is, for example, a system that manages the pitting corrosion propagation degree by predicting a pitting corrosion propagation degree from the past to the present based on information measured by an actual machine (referred to as “measurement information” or “measured information”, hereinafter), and predicting a future pitting corrosion propagation degree based on an operation plan assumed in the future. Further, the pitting corrosion propagation degree management system 100 generates display information for making a prediction result of the pitting corrosion propagation degree and the like to be displayed on a display part, for example. Note that the measured information includes time information at a time of measuring a relevant measured value.

As illustrated in FIG. 2, the pitting corrosion propagation degree management system 100 includes a measured information acquiring part 110, a calculator 120, a storage 130, a user interface 140, and a progress controller 150. The pitting corrosion propagation degree management system 100 is, for example, a computer system, but it may also be an aggregation of individual devices and apparatuses having functions of respective elements.

The measured information acquiring part 110 is an interface that acquires measurement data required for the pitting corrosion propagation degree management from the on-site control apparatus 40. The measured information acquiring part 110 acquires, from measurement data taken into the on-site control apparatus 40, measured information (also referred to as measurement data, hereinafter) regarding the steam turbine 10 during operation required for the pitting corrosion propagation degree management, at a predetermined time interval (measured information acquisition cycle) of one minute or the like, for example.

The measured information is a generator output (MW) and water quality parameters. The water quality parameters are, for example, a chlorine concentration (μg/L), an acid electric conductivity (μS/m), a silica concentration (μg/L), a hydrazine concentration (μg/L), a sodium concentration (μg/L), an SO₄ concentration (μg/L), a dissolved oxygen concentration (μg/L), and pH (−).

The measured information acquiring part 110 outputs the acquired measured information to a measured information storage 132 of the storage 130. The measured information storage 132 houses and stores this measured information.

The calculator 120 includes a dry-wet alternation determination section 121, an average value calculator 122, a pitting corrosion propagation calculator 123, a future predictor 124, and a display information generator 125.

The dry-wet alternation determination section 121, the average value calculator 122, and the pitting corrosion propagation calculator 123 to be explained below, of the calculator 120, are parts related to fixed cycle calculation processing being calculation processing regarding a pitting corrosion propagation degree a from the past to the present.

The dry-wet alternation determination section 121 derives a range of the generator output in a cycle (pitting corrosion propagation calculation cycle ΔT) of one hour or the like, for example, for calculating the pitting corrosion propagation degree, and determines the presence/absence of the dry-wet alternation.

The average value calculator 122 derives, based on measured information acquired for each measured information acquisition cycle of one minute or the like, for example, by the measured information acquiring part 110, an average value of each of the water quality parameters in the pitting corrosion propagation calculation cycle ΔT.

The pitting corrosion propagation calculator 123 calculates a pitting corrosion propagation degree in the pitting corrosion propagation calculation cycle ΔT, based on a dry-wet alternation time ΔT₁ and the average value of each of the water quality parameters in the pitting corrosion propagation degree calculation cycle ΔT.

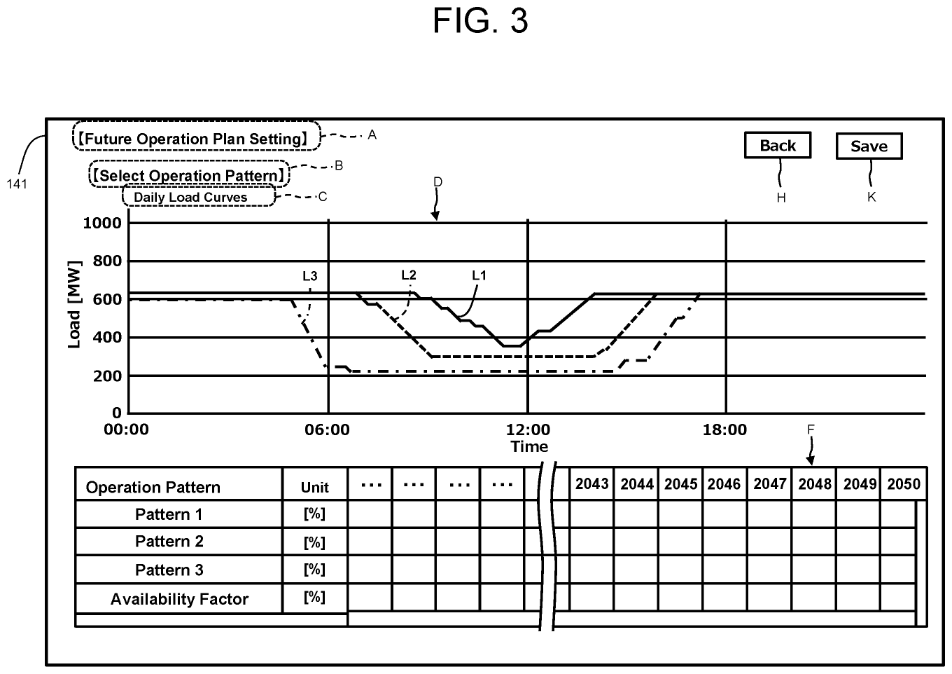

The future predictor 124 performs future prediction processing being calculation processing regarding a pitting corrosion propagation degree a in the future, namely, in a period after the present. The future predictor 124 integrates pitting corrosion propagation degrees regarding each operation pattern previously calculated and housed in the storage 130, based on information input as a future operation plan (refer to FIG. 3) in the user interface 140 to be described later, to thereby calculate a pitting corrosion propagation degree of one year, as the future prediction processing. Here, the information input as the operation plan is a condition of calculation, and thus it will be also called an operation condition hereinbelow.

The operation pattern is a pattern of an output [MW] at each time in one day, in other words, a pattern of temporal change of an output [MW] in one day. A ratio (%) of the number of days of each of the previously-set plurality of operation patterns to the number of days of one year is input. Note that hereinbelow, the operation pattern is sometimes referred to as a daily load condition, and a curve indicating the operation pattern is sometimes referred to as a daily load curve.

With respect to each pattern of a start up condition and the daily load condition, a contribution amount Δdj per one hour to the pitting corrosion propagation degree is previously calculated, and stored and housed in a pitting-corrosion-propagation-degree-by-pattern storage 135 of the storage 130. Note that the values of these contribution amounts may also be housed in a program storage 133 together with a program, as a data part in the program installed and housed in the program storage 133 of the storage 130.

The future predictor 124 multiplies the contribution amount Δdⱼ to the pitting corrosion propagation degree corresponding to each operation pattern, by an in-operation time of each operation pattern input as the future operation plan to calculate an annual pitting corrosion propagation degree ΔDⱼ of the operation pattern, and a total value thereof is calculated as an annual pitting corrosion propagation degree ΔDₘ. The future predictor 124 adds the pitting corrosion propagation degree ΔDₘ to a pitting corrosion degree Dₘ₋₁ of the previous year, to thereby calculate a pitting corrosion degree Dₘ of the calculation target year. Further, it is assumed that the pitting corrosion propagation degree ΔDₘ of the year increases linearly. Note that here, the in-operation time is one obtained by multiplying an availability factor input on an input screen 141 in FIG. 3 to be described later by a total time of one year.

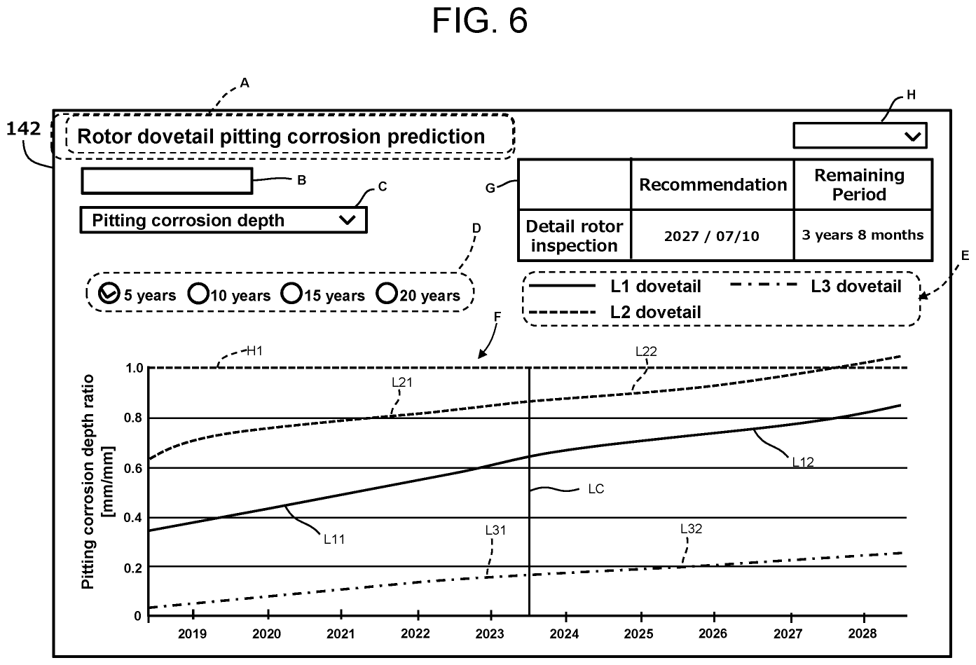

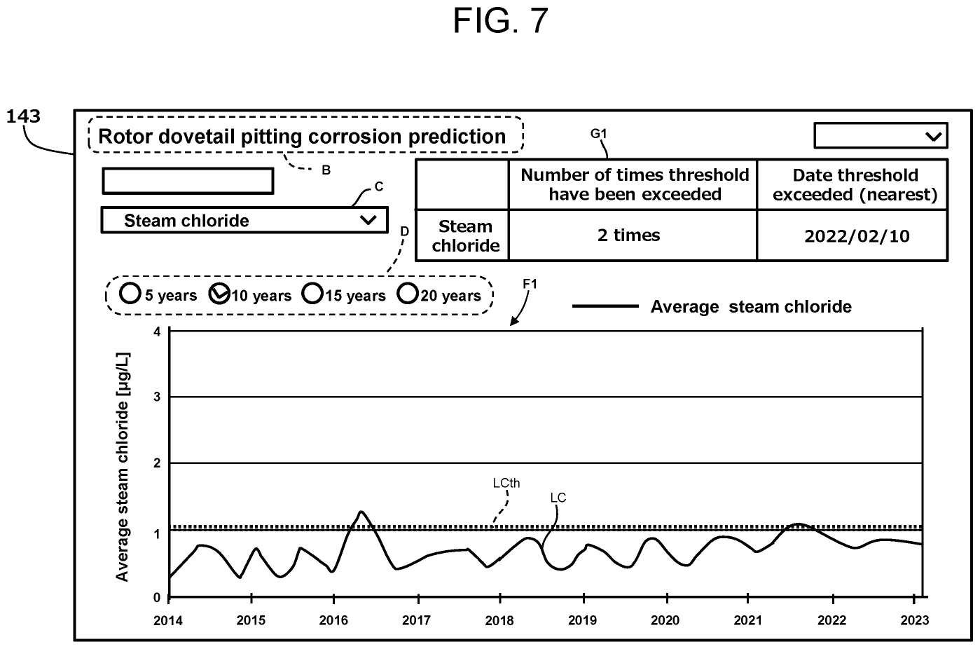

The display information generator 125 generates display information of an input screen and an output screen to be displayed on the user interface 140. The input screen will be explained later while citing FIG. 3, and the output screen will be explained later while citing FIG. 6 and FIG. 7.

The storage 130 includes an input information storage 131, the measured information storage 132, the program storage 133, a calculation result storage 134, the pitting-corrosion-propagation-degree-by-pattern storage 135, a template storage 136, and a display information storage 137. The storage 130 is realized by, for example, a hard disk drive, a nonvolatile memory device, or the like. The storage 130 may not be physically integrated with the pitting corrosion propagation degree management system 100, and may be connected to the system via a not-illustrated network.

The input information storage 131 stores, for example, a future operation plan, various setting conditions, and the like input via the user interface 140.

The measured information storage 132 sequentially houses and stores the measured information acquired by the measured information acquiring part 110.

The program storage 133 houses a program installed in the pitting corrosion propagation degree management system 100. At this time, the program storage 133 also houses data for calculation pertaining to the program.

The calculation result storage 134 sequentially houses and stores results calculated by the calculator 120. The calculation result storage 134 stores, as information regarding the pitting corrosion propagation degree from the past to the present (past pitting corrosion propagation degree), a calculation result of the pitting corrosion propagation degree from the past to the present in the fixed cycle calculation processing to be explained later while citing FIG. 6, and the like, for example. Note that this information functions as past pitting corrosion propagation degree related information.

Further, the calculation result storage 134 stores, as information regarding a future pitting corrosion propagation degree to be explained later while citing FIG. 6, calculation results of a pitting corrosion propagation degree in the future (future pitting corrosion propagation degree), an inspection threshold value, an inspection recommendation date, and the like, for example. These pieces of information function as future pitting corrosion propagation degree related information.

Here, the inspection threshold value is a threshold value indicating a pitting corrosion propagation degree by which the performance of inspection is recommended. Further, the inspection recommendation date is a date (year/month/day) at which the performance of inspection is recommended.

The pitting-corrosion-propagation-degree-by-pattern storage 135 houses the previously-calculated pitting corrosion propagation degree and the like regarding each pattern in the future operation plan input via the user interface 140. Note that the pitting-corrosion-propagation-degree-by-pattern storage 135 may also be a part of the program storage 133. Specifically, it may be housed in the program storage 133 as a part of the data for calculation pertaining to the program, and that part may be called the pitting-corrosion-propagation-degree-by-pattern storage 135.

The template storage 136 houses templates being common parts when generating images to be displayed on the user interface 140.

The display information storage 137 houses the display information generated by the display information generator 125.

The user interface 140 includes a display part that displays various pieces of information to a user (manager), and an input device with which the user inputs the various pieces of information. The display part is formed of a display or the like, for example. Further, the display part may also be formed of a touch panel including a function of a screen for display and including a function as an input device capable of directly performing input on the screen. The input device may be formed of, for example, a keyboard, a mouse, and the like. The input device includes an information exchange terminal with respect a USB port or the like, capable of inputting various setting conditions and the like based on a predetermined format, for example. Note that the input function of the display part may also be used, as described above.

Regarding the user interface 140, an input part thereof, in particular, may be different between one for a manager of the power plant 1 and one for a manager of a manufacturer of the steam turbine 10.

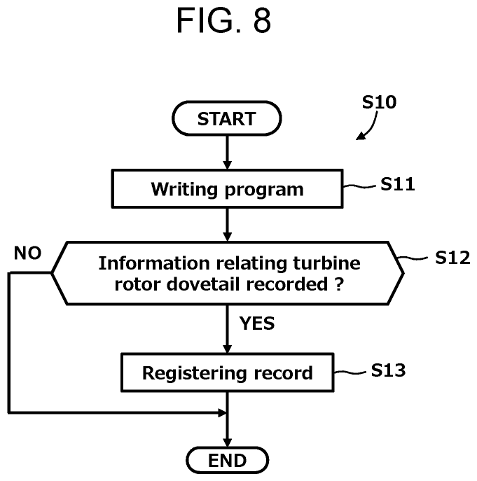

The progress controller 150 controls the progress of respective flows in a pitting corrosion propagation degree management method performed by the pitting corrosion propagation degree management system 100. The progress controller 150 also performs determination regarding respective determination steps in these flows. Concretely, the progress controller 150 performs determination in flows illustrated in FIG. 8 to FIG. 10 to be described later, and further, it commands a part that should fulfill a relevant function in the pitting corrosion propagation degree management system 100 in each step to execute the function. As the progress controller 150, for example, a programmable logic controller may be used.

### Input Screen

FIG. 3 is a diagram illustrating one example of an input screen 141 of a future operation plan to be displayed on the user interface 140 in the pitting corrosion propagation degree management system 100 according to the first embodiment.

At an A portion at the upper left of the input screen 141, a heading of “Future operation plan setting” is displayed.

At a B portion below the heading, a small title of “Select Start Up Pattern” is displayed, and at a C portion below the small title, a title of “Select Operation Pattern” is displayed.

Further, at a D portion below the title, a small title of “Daily Load Curve” is displayed, and below the small title, in the example of FIG. 3, a graph F illustrating three curves indicating temporal change of loads in one day (daily load curves) as operation patterns, is displayed. In the graph F, a horizontal axis is a time in one day, and a vertical axis is a load (“Load [MW]”). Here, the load may be set to an output [MW] of the generator 20.

Below the graph D, a table F for inputting operation pattern is displayed. Respective horizontal columns in the table F are fields for inputting the operation pattern, a unit, and the year to which the present belongs and respective years thereafter. Respective vertical rows in the table F correspond to patterns 1 to 3 and an availability factor [%] in each year. The input field of each of the patterns 1 to 3 corresponds to a ratio [%] of the number of days of performing the operation of the relevant pattern to the number of days of one year. A value of the availability factor [%] is a ratio [%] of an annual operation time. As described above, the operation plan in the future, namely, the start up pattern and the operation pattern in each year can be set in an arbitrary manner.

At the upper right portion of the input screen 141, a selection display H of “Back” and a selection display K of “Save” are displayed. When “Save” is pressed, the information input in the table F is housed and stored in the display information storage 137. Further, when “Back” is pressed without pressing “Save”, the display of information input in the table F returns to the display before the input.

Note that here, when it is expressed such that the selection display is “pressed”, this is set to collectively mean an operation of specifying or selecting a relevant portion by acting on the portion from the outside, such as an operation of touching on the touch screen, or an operation of clicking with a cursor. The same applies to the description below.

### Pitting Corrosion Propagation Evaluation

Here, a pitting corrosion propagation evaluation in the fixed cycle calculation processing will be described. Hereinafter, a flow in each pitting corrosion propagation calculation cycle ΔT will be explained. Here, the cycle of the fixed cycle calculation processing will be called a pitting corrosion propagation calculation cycle ΔT. Specifically, the fixed cycle calculation processing is performed for each pitting corrosion propagation calculation cycle ΔT (every hour, for example).

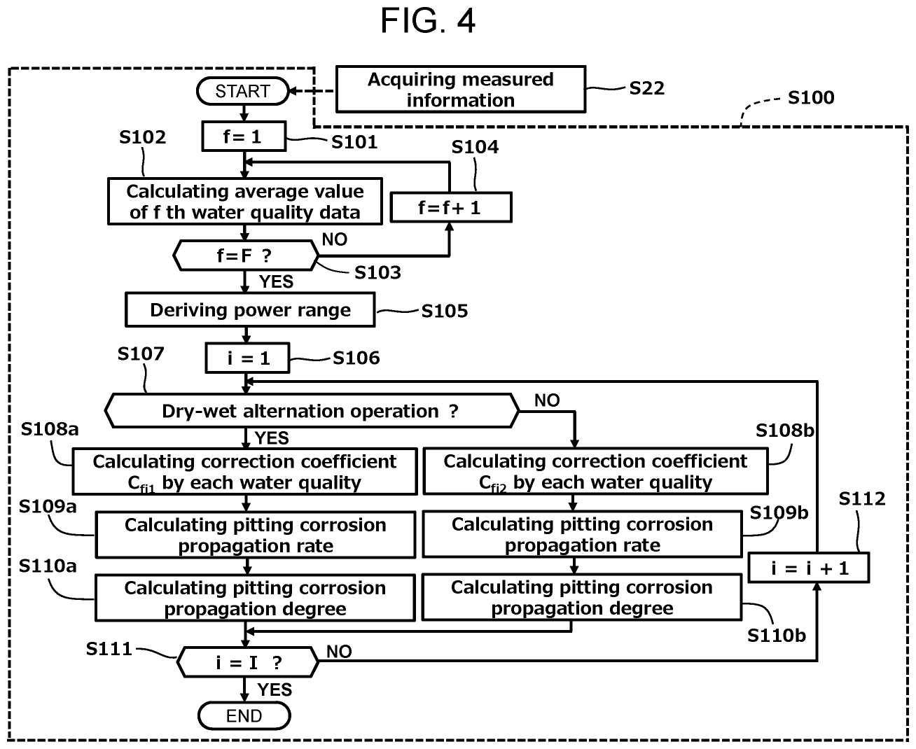

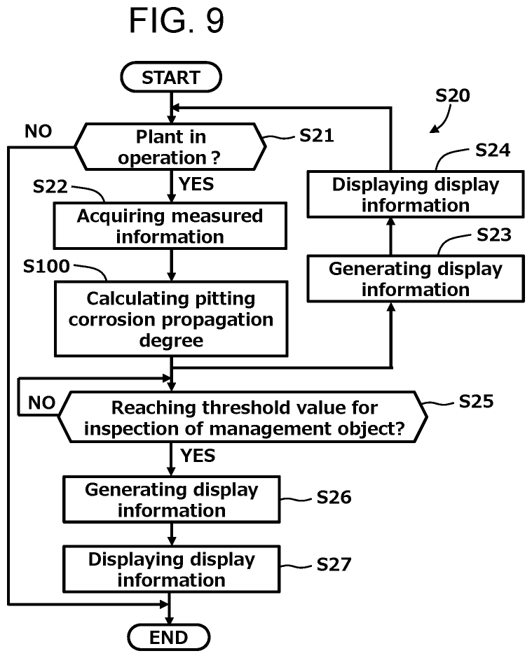

FIG. 4 is a flow chart illustrating a procedure of a pitting corrosion propagation evaluation step S100 performed by the pitting corrosion propagation degree management system 100 according to the first embodiment. Here, FIG. 4 illustrates details of a procedure of a fixed cycle calculation step S100 continued from a plan information acquisition step S22 to be described later while citing FIG. 9.

In advance of the pitting corrosion propagation evaluation step S100, the measured information acquiring part 110 acquires the measured information including the generator output from the on-site control apparatus 40 (step S22).

As the pitting corrosion propagation evaluation step S100, the progress controller 150 first sets f to 1 (step S101). Here, f is a number when giving an order to a type of a water quality parameter. Further, F is the total number of types of water quality parameters. For example, from the water quality parameters of the chlorine concentration, the acid electric conductivity, the silica concentration, the hydrazine concentration, the sodium concentration, the SO₄ concentration, the dissolved oxygen concentration, and pH, the water quality parameter to be a target is selected. When selecting all of them, there are eight types of the water quality parameters, and a maximum value F of f is 8.

Next, the average value calculator 122 calculates an average value of pieces of time data (water quality data) acquired at each acquisition cycle of the f-th water quality parameter in the pitting corrosion propagation calculation cycle ΔT (step S102). For example, an average value over the pitting corrosion propagation calculation cycle ΔT of one hour, for example, regarding the water quality data acquired at the acquisition cycle of one minute, for example, is calculated. Next, the progress controller 150 determines whether or not f has reached F (step S103), and when it is determined that f has not reached F (NO in step S103), 1 is added to f (step S104), and step S102 and step S103 are repeated.

When it is determined that f has reached F (YES in step S103), the dry-wet alternation determination section 121 derives a range of the generator power during the pitting corrosion propagation calculation cycle ΔT. Concretely, the dry-wet alternation determination section 121 derives a highest value GLH and a lowest value GLL of the generator power during the pitting corrosion propagation calculation cycle ΔT (step S105).

Next, the progress controller 150 sets i to 1 (step S106). Here, i is a serial number of the L1 dovetail to the L3 dovetail of the low-pressure turbine 13 to be an evaluation target. Regarding the L1 dovetail to the L3 dovetail, i is set to 1 to 3. Note that a maximum value of i is set to I. In this case, I is 3.

Next, the dry-wet alternation determination section 121 determines whether or not there exists a dry-wet alternation operation in the case of i (step S107). Regarding the presence/absence of the dry-wet alternation operation, when GLCi exists between GLH and GLL in the pitting corrosion calculation cycle, it is determined that the dry-wet alternation operation exists, and when GLCi does not exist between GLH and GLL, it is determined that the dry-wet alternation operation does not exist. GLCi is a generator output when the dry-wet alternation is switched, and is a constant set for each turbine design and stage. Specifically, when a value of JDG calculated by the following equation (1) is negative, it is set that the dry-wet alternation operation exists. Note that the value of GLCi is housed in the program storage 133 together with the program, as data pertaining to the program.

$$JDG = ( GLH - GLCi ) \times ( GLL - GLCi ) \qquad ( 1 )$$

First, a case where it is determined that the dry-wet alternation operation exists in the pitting corrosion calculation cycle (YES in step S107) will be explained.

First, the pitting corrosion propagation calculator 123 calculates a correction coefficient C_{fi1} (f=1 to F) by using an average value of the f-th water quality parameter (step S108a). Here, each correction coefficient C_{fi1} is a correction coefficient, based on the water quality, of a pitting corrosion propagation rate (da/dt) when there exists the dry-wet alternation operation. A calculation equation for calculating the correction coefficient C_{fi1}, coefficients of the calculation equation, and so on are housed in the program storage 133 as data pertaining to the program.

Next, the pitting corrosion propagation calculator 123 calculates the pitting corrosion propagation rate (da/dt) (step S109a).

The pitting corrosion propagation rate (da/dt) is calculated by the pitting corrosion propagation calculator 123 as a value of function that depends on the correction coefficient C_{fi1} (f=1 to F) based on each water quality parameter. Note that respective coefficients used for this function, and so on are also housed in the program storage 133 as data pertaining to the program.

Next, the pitting corrosion propagation calculator 123 multiplies the pitting corrosion propagation rate (da/dt) by the pitting corrosion propagation calculation cycle ΔT, to thereby calculate a pitting corrosion propagation degree of the evaluation target i in the pitting corrosion propagation calculation cycle ΔT (step S110a). Further, this pitting corrosion propagation degree is added to the pitting corrosion degree at the time point of starting the pitting corrosion propagation calculation cycle ΔT of the evaluation target i, to thereby calculate a new pitting corrosion degree. Note that an initial value of a pitting corrosion depth is housed in the program storage 133 as data pertaining to the program. Note that when a defect removal (skin cut) of cutting a surface of the dovetail has been performed at the time of periodic inspection, a pitting corrosion initial value right after the periodic inspection is reset to 0.

Next, a case where it is not determined that the dry-wet alternation operation exists in the pitting corrosion calculation cycle (NO in step S107) will be explained.

First, the pitting corrosion propagation calculator 123 calculates a correction coefficient C_{fi2} (f=1 to F) by using the average value of the f-th water quality parameter (step S108b). Here, each correction coefficient C_{fi2} is a correction coefficient, based on the water quality, of the pitting corrosion propagation rate (da/dt) when the dry-wet alternation operation does not exist. A calculation equation for calculating the correction coefficient C_{fi2}, coefficients of the calculation equation, and so on are housed in the program storage 133 as data pertaining to the program.

Next, the pitting corrosion propagation calculator 123 calculates the pitting corrosion propagation rate (da/dt), similarly to step S109a (step S109b). Besides, the pitting corrosion propagation calculator 123 multiplies the pitting corrosion propagation rate (da/dt) by the pitting corrosion propagation calculation cycle ΔT, to thereby calculate a pitting corrosion propagation degree of the evaluation target i in the pitting corrosion propagation calculation cycle ΔT, similarly to step S110a (step S110b). Further, this pitting corrosion propagation degree is added to the pitting corrosion degree at the time point of starting the pitting corrosion propagation calculation cycle ΔT of the evaluation target i, to thereby calculate a new pitting corrosion degree.

Next, the progress controller 150 determines whether or not i has reached the maximum value I (step S111). When it is not determined that i has reached the maximum value I (NO in step S111), 1 is added to the value of i (step S112), and the processing from step S107 to step S111 is repeated.

When it is determined that i has reached the maximum value I (YES in step S111), the pitting corrosion propagation evaluation step S100 regarding the pitting corrosion propagation calculation cycle ΔT in the fixed cycle calculation processing is terminated.

### Calculation of Future Pitting Corrosion Propagation Degree

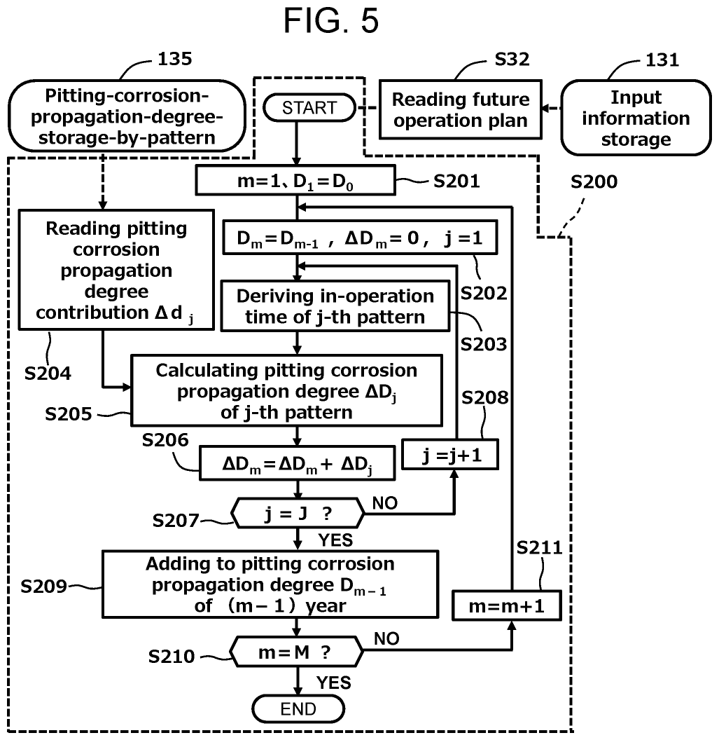

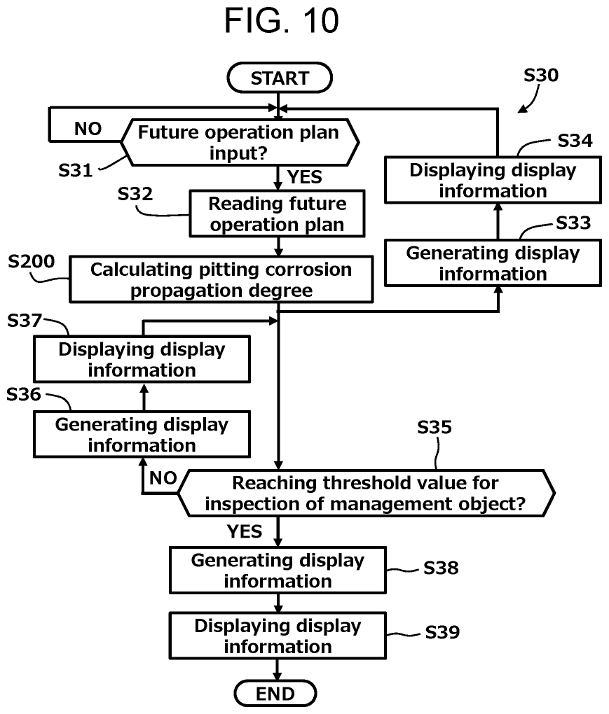

FIG. 5 is a flow chart illustrating a procedure of a future prediction calculation step (future prediction step) S200 performed by the future predictor 124 of the pitting corrosion propagation degree management system 100 according to the first embodiment. FIG. 5 illustrates details of the procedure of the future prediction step S200 continued from a future operation plan reading step S32 to be described later while citing FIG. 10. Note that FIG. 5 illustrates an individual flow for each of the evaluation targets (L1 dovetail to L3 dovetail). Although not illustrated, the future predictor 124 automatically performs evaluation in an order of the respective evaluation targets (L1 dovetail to L3 dovetail).

In the future prediction step S200, the pitting corrosion propagation calculation is not carried out but a pitting corrosion propagation degree for each year is calculated by using a pitting corrosion propagation degree previously calculated for each pattern and housed in the pitting-corrosion-propagation-degree-by-pattern storage 135, and an input value of each pattern for each year input via the user interface 140.

First, the future predictor 124 sets m to 1, and sets D₁ to D₀ (step S201). Here, m indicates an order of year such as a year 2045, for example. Further, D₀ is an initial value of the pitting corrosion degree calculation in the initial year of the future calculation (for example, the year to which the present belongs, or the following year). For example, if m=1 indicates the year to which the present belongs, D₀ is a present pitting corrosion degree, namely, a present value in the fixed cycle calculation. The value of D₀ is housed in the calculation result storage 134. Further, the calculation result storage 134 houses the latest pitting corrosion degree calculated by the following steps.

Next, the future predictor 124 sets Dₘ to Dₘ₋₁, sets ΔDₘ to 0, and sets j to 1 (step S202). Specifically, the initial value of the pitting corrosion degree of the calculation target year is set to the pitting corrosion degree at the end of the previous year, and the pitting corrosion propagation degree ΔDₘ of the calculation target year (year m) is set to 0. Here, j (j=1 to J) is a number of future operation pattern on the input screen 141 in FIG. 3. The respective patterns related to the “operation pattern” in the table F are arranged in serial order and the total number thereof is set to J, and in the case of the input screen 141 illustrated in FIG. 3, J is 3.

Next, the future predictor 124 derives the in-operation time of the j-th pattern (step S203). Concretely, the future predictor 124 multiplies the availability factor of the j-th pattern of the m-th year input on the input screen 141 of the user interface 140 in FIG. 3 and housed in the input information storage 131, by a total time of one year, to thereby calculate the in-operation time.

Next, the future predictor 124 reads, from the pitting-corrosion-propagation-degree-by-pattern storage 135, the previously-calculated contribution amount Δdj per one hour to the pitting-corrosion-propagation-degree-by-pattern (step S204), and multiplies the contribution amount Δdj by the in-operation time of the j-th pattern, to thereby calculate the annual pitting corrosion propagation degree ΔDⱼ of the operation pattern j (step S205).

Next, the future predictor 124 sequentially adds the pitting corrosion propagation degrees ΔDⱼ of the j-th pattern derived in step S205, to thereby calculate the pitting corrosion propagation degree ΔDₘ in the m-th year (step S206). Further, the future predictor 124 determines whether or not j has reached J (step S207), and when j has not reached J (NO in step S207), the future predictor 124 adds 1 to j (step S208), and repeats the processing from step S203 to step S207.

When the future predictor 124 determines that j has reached J (YES in step S207), it calculates a new pitting corrosion degree Dₘ in the m-th year (step S209). Specifically, the future predictor 124 reads the pitting corrosion degree Dₘ₋₁ in the (m−1)-th year housed in the calculation result storage 134, and adds the pitting corrosion propagation degree ΔDₘ in the m-th year calculated in step S206 to the pitting corrosion degree Dₘ₋₁, to thereby calculate a new pitting corrosion degree Dₘ in the m-th year. The new pitting corrosion degree Dₘ in the m-th year is housed in the calculation result storage 134.

Next, the future predictor 124 determines whether or not m has reached M (step S210), and when m has not reached M (NO in step S210), the future predictor 124 adds 1 to m (step S211), and repeats the processing from step S202 to step S210. Further, when the future predictor 124 determines that m has reached M (YES in step S210), it terminates the future prediction step S200.

### Output Screen

FIG. 6 illustrates an output screen 142 indicating one example of results of the fixed cycle calculation and the future prediction calculation to be displayed on the user interface 140 in the pitting corrosion propagation degree management system 100 according to the first embodiment.

At an A portion on the top, a heading of “Rotor dovetail pitting corrosion prediction” is displayed.

At a B portion below the heading, a name of a relevant plant is displayed.

At a C portion below the B portion, a heading of “Pitting corrosion depth” is displayed. At the C portion, it is possible to select a screen of water quality parameter as illustrated in FIG. 7, from a pull-down display displayed by pressing a check portion on the right side, and thus targeted information can be switched.

At a lower portion of the output screen 142, a graph F indicating the results of the fixed cycle calculation and the future prediction calculation is displayed. A horizontal axis of the graph indicates serial years, and a display position of the year is set to an intermediate time point of each of the serial years (June 30, for example). Further, a vertical axis of the graph indicates “Pitting corrosion depth ratio [mm/mm]”.

At a D portion above the graph F, options of “5 years”, “10 years”, “15 years”, and “20 years” are displayed. In the case of the output screen 142, “5 years” is selected, so that as the serial years on the horizontal axis of the graph F, past 5 years are displayed on the left side, and future 5 years are displayed on the right side of a solid line LC that indicates the present and set at a center of the horizontal axis.

Curves L11 to L31, and curves L12 to L32 in the graph F represent the pitting corrosion degrees of the L1 dovetail to the L3 dovetail, respectively. The curves L11 to L31 on the left side of the solid line LC are parts indicating the results of the fixed cycle calculation up to the present. The curves L12 to L32 on the right side of the solid line LC are parts indicating the results of the future calculation. At an E portion at the upper right of the graph F, names of evaluation parts indicated by types of lines and curves are displayed. Note that the display of the curves L11 to L31 and the curves L12 to L32 is set to employ a method of discrimination (based on types of lines, colors, and the like) corresponding to the lines indicating the management targets displayed at the E portion. It is also possible to discriminate between the result of the fixed cycle calculation and the result of the future calculation, according to need.

As will be described later, the future prediction processing of creating the future curves L12 to L32 is performed only when it is determined that the future operation plan has been input. An initial value of pitting corrosion at this time is a final value when it is determined that the future operation plan has been input. On the other hand, the fixed cycle calculation of the pitting corrosion propagation degree of creating the past curve is performed for each pitting corrosion propagation calculation cycle ΔT (every hour, for example). Therefore, the curves L11 to L31 of the past parts change hourly, for example, and final values of the past parts, namely, intersection points of the past parts with the solid line LC increase continuously. Accordingly, a deviation between the final values of the past parts, namely, the intersection points of the past parts with the solid line LC, and starting points of the future parts, namely, intersection points of the future parts with the solid line LC increases hourly.

The graph F in FIG. 6 indicates a case of a time point where the intersection points of the curves L11 to L31 of the past parts with the solid line LC and the starting points of the curves L12 to L32 of the future parts, namely, the intersection points of the future parts with the solid line LC match respectively, namely, a time point within the pitting corrosion propagation calculation cycle ΔT, for example, within one hour from when the future prediction processing is performed and results thereof are displayed as the future parts.

In the vertical axis direction of the graph F, a broken line H1 indicating a level of inspection threshold value is displayed. In correspondence to this, a table G as an alarm display is displayed at the upper right of the output screen 142. In the table G, “Recommendation” and “Remaining Period” of “Detail rotor inspection” are displayed. Note that there is a case where the table G is displayed and there is a case where it is not displayed, depending on a determination result to be described later while citing FIG. 9 and FIG. 10.

Above the table G of the output screen 142, a pull-down selection field H having a selection display (“v” portion) is displayed. When the selection display is pressed, pull-down selection candidate screens such as the input screen 141 of the future operation plan are displayed, and a screen to be transited can be selected.

Note that out of the items displayed on the output screen 142, the A portion, the B portion, the C portion, and the H portion are common to the respective output screens including an output screen 143 illustrated in FIG. 7.

FIG. 7 illustrates the output screen 143 indicating one example of water quality data to be displayed on the user interface in the pitting corrosion propagation degree management system according to the first embodiment. Hereinafter, an explanation regarding parts common to those of the output screen 142 will be omitted.

At a C portion, “Steam chloride” is displayed as a selected heading. Specifically, the output screen 143 indicates a chlorine concentration out of the pieces of water quality data.

In a graph F1 of the output screen 143, a curve LC indicating a chlorine concentration with respect to a threshold value LCth [μg/L] of a chlorine concentration [μg/L] after being subjected to average value processing (“Average steam chloride [μg/L]”) is displayed.

At a D portion being a selection field of a span on a horizontal axis, 10 years are selected. Here, the chlorine concentration is an actual value from the past to the present, so that the curve LC indicates actual values from the past 10 years to the present.

In the graph F1, the straight line LCth indicating the threshold value of the value on the vertical axis, is displayed. In the case illustrated in the graph F1, the value of the curve LC indicating the actual value of the chlorine concentration exceeded the straight line LCth indicating the threshold value two times.

As an alarm display corresponding to this, a table G1 at the upper right displays the number of times at which the value of the curve LC indicating the actual value of the chlorine concentration exceeded the straight line LCth indicating the threshold value, and the date at which the value of the curve LC exceeded the straight line LCth most recently, within a range displayed in the graph F1.

The above is the explanation regarding the output screen 142 and the output screen 143 while citing FIG. 6 and FIG. 7. Note that although the case where the water quality parameter is the chlorine concentration is explained as an example on the output screen 143, by pressing the C portion on the output screen, it is possible to display an output screen regarding another water quality such as the acid electric conductivity or the silica concentration.

Next, each flow in a pitting corrosion propagation degree management method performed by the pitting corrosion propagation degree management system 100 according to the first embodiment will be explained.

### Basic Information Setting Processing

FIG. 8 is a flow chart for explaining a basic information initial setting step (S10) in the pitting corrosion propagation degree management system 100 according to the first embodiment. The basic information setting processing is processing performed by a manager, a technical worker, and the like of a manufacturer.

First, a program is written into the pitting corrosion propagation degree management system 100 (step S11). The written program is housed and stored in the program storage 133 of the pitting corrosion propagation degree management system 100. Here, when the program is written, data information such as various parameters for calculation, a set value, and an initial value of a pitting corrosion degree, is written in an accompanied manner. The following steps presuppose a state in which the pitting corrosion propagation degree management system 100 is started up after installing the program therein.

Next, it is determined whether or not there are records related to a turbine rotor dovetail (step S12). When it is not determined that these records exist (NO in step S12), the present flow is terminated.

When it is determined that these records exist (YES in step S12), the records are registered (step S13).

The above is the flow of the basic information setting step S10.

### Fixed Cycle Calculation Processing

FIG. 9 is a flow chart for explaining a fixed cycle calculation step (S20) in the pitting corrosion propagation degree management system 100 according to the first embodiment.

First, the progress controller 150 determines whether or not the power plant 1 is in operation (step S21). The determination is performed based on the generator output, for example, out of the pieces of information stored in the measured information storage 132.

When it is not determined that the power plant 1 is in operation (NO in step S21), the flow is terminated without carrying out the fixed cycle calculation processing.

When it is determined that the power plant 1 is in operation (YES in step S21), the measured information acquiring part 110 acquires the measured information as operation data from the on-site control apparatus 40 (step S22). Here, the measurement information (measured information) to be acquired is the data regarding the generator output and the respective water quality parameters, as described above.

Next, the calculation of the pitting corrosion propagation degree in step S100 explained while citing FIG. 4, and so on are carried out. The generated calculation result is housed and stored in the calculation result storage 134.

The display information generator 125 generates display information based on the calculation result stored in the calculation result storage 134 and the information stored in the template storage 136 (step S23). Further, the display information generator 125 outputs the generated display information to the display information storage 137 and the user interface 140. The display information storage 137 stores the display information.

The user interface 140 displays the display information output from the display information generator 125 on the display part, as illustrated in FIG. 6 and FIG. 7 (step S24).

Here, the display information generator 125 outputs the display information based on the calculation result to the display information storage 137 and the user interface 140 for each pitting corrosion propagation calculation cycle ΔT (one hour, for example). Accordingly, the curve from the past to the present in the graph F indicating the calculation result of the output diagram 142 exemplified in FIG. 6 displayed on the display part, is updated for each pitting corrosion propagation calculation cycle ΔT.

The processing from step S21 to step S24 described above is repeated for each pitting corrosion propagation calculation cycle ΔT, namely, every hour, for example. Accordingly, the part of the fixed cycle calculation result displayed in the graph F exemplified by the output screen 142 in FIG. 6 is updated for each pitting corrosion propagation calculation cycle ΔT.

Next, the progress controller 150 performs determination regarding each of the L1 dovetail to the L3 dovetail being management targets, based on the calculation result of the pitting corrosion propagation degree based on the calculation result in step S100. These determinations are also performed for each pitting corrosion propagation calculation cycle ΔT (one hour, for example).

The progress controller 150 determines whether or not each pitting corrosion propagation degree of each management target based on the calculation result in step $100 has reached an inspection threshold value (step S25).

When it is not determined that the pitting corrosion propagation degree has reached the inspection threshold value of a turbine rotating part 10a (NO in step S25), this determination is repeated for each pitting corrosion propagation calculation cycle ΔT.

When it is determined that the pitting corrosion propagation degree has reached the inspection threshold value of the turbine rotating part 10a (YES in step S25), the progress controller 150 outputs information regarding the date at which the pitting corrosion propagation degree has reached the inspection threshold value (information related to the inspection recommendation date) to the calculation result storage 134. The calculation result storage 134 stores this information. The display information generator 125 generates display information based on the calculation result stored in the calculation result storage 134 and the information stored in the template storage 136 (step S26). Further, the display information generator 125 outputs the generated display information to the display information storage 137 and the user interface 140. The display information storage 137 stores the display information.

The user interface 140 displays a screen including the information related to the inspection recommendation date, based on the display information output from the display information generator 125 (step S27). Here, the information related to the inspection recommendation date on the screen corresponds to a part of “Detail rotor inspection” indicated in the table G of the output screen 142 illustrated in FIG. 6. Note that FIG. 6 illustrates a case where the inspection recommendation date does not come in a range of the fixed cycle calculation processing, and the inspection recommendation date will come in a range of the future prediction processing.

The above is the flow of the fixed cycle calculation processing. Next, a flow of the future prediction processing will be explained.

### Future Prediction Processing

FIG. 10 is a flow chart for explaining a future prediction calculation step (S30) in the pitting corrosion propagation degree management system 100 according to the first embodiment.

Here, on the date of the introduction of the pitting corrosion propagation degree management system 100, the future operation plan illustrated in FIG. 3 is initially set. After the introduction, a user inputs the future operation plan in a unit of one year, in the table F of the input screen 141 illustrated in FIG. 3 of the user interface 140.

For example, by pressing the selection button of the pull-down selection field H in the screen examples such as the output screen 142 illustrated in FIG. 6 and the output screen 143 illustrated in FIG. 7, selection screen items including the input screen 141 of the future operation plan are displayed in a pull-down display. When the input screen 141 is selected at the pull-down selection field H, a screen of the display part of the user interface 140 is switched to the input screen 141 of the future operation plan illustrated in FIG. 3. At this time, the display information generator 125 inputs information related to the selection of the input screen 141 from the user interface 140, and outputs display information for displaying the input screen 141 to the user interface 140.

The user inputs the future operation plan, and then presses the “Save” display on the input screen 141 in FIG. 3. The user interface 140 receives the input from the “Save” display, and outputs information related to the future operation plan to the input information storage 131. The input information storage 131 stores the information related to the future operation plan.

Upon receiving information from the user interface 140 in accordance with the pressing of the “Save” display, the progress controller 150 determines that the future operation plan has been input.

Under the background as described above, in the procedure of the future prediction processing illustrated in FIG. 10, the progress controller 150 first determines whether or not the future operation plan has been input (step S31).

When, in the determination in step S31, it is determined that the future operation plan has not been input (NO in step S31), the progress controller 150 repeats this determination for each pitting corrosion propagation calculation cycle ΔT.

When, in the determination in step S31, it is determined that the future operation plan has been input (YES in step S31), the future predictor 124 reads the program for executing the future prediction processing from the program storage 133, and the future operation plan stored in the input information storage 131 (step S32).

Next, the future predictor 124 calculates a future pitting corrosion propagation degree by the calculation method explained while referring to FIG. 5, and outputs a calculation result to the calculation result storage 134 (step S200). The calculation result storage 134 stores the calculation result.

The display information generator 125 generates display information based on the calculation result stored in the calculation result storage 134 and the information stored in the template storage 136 (step S33). Further, the display information generator 125 outputs the generated display information to the display information storage 137 and the user interface 140. The display information storage 137 stores the display information.

The user interface 140 displays the display information output from the display information generator 125 on the display part as illustrated in the example of FIG. 6 (step S34).

Here, the display information generator 125 executes the calculation processing of the future pitting corrosion propagation degree in step S200 every time it is determined that the future operation plan has been input in step S31 (YES in step S31), and outputs the display information based on the calculation result to the display information storage 137 and the user interface 140. Accordingly, the graph F (FIG. 6) indicating the calculation result regarding the future pitting corrosion propagation degree displayed on the display part, is updated every time the calculation processing of the future pitting corrosion propagation degree in step S200 is executed. In other words, the graph F indicating the calculation result regarding the future pitting corrosion propagation degree is updated every time the information in accordance with the pressing of “Save” at the K portion on the input screen 141 of the future operation plan is received.

The processing from step S31 to step S34 described above is repeated every time it is determined that the future operation plan has been input. Accordingly, the curves indicating the calculation results regarding the future pitting corrosion propagation degrees displayed in the graph F exemplified by the output screen 142 in FIG. 6, are updated each time.

Next, the progress controller 150 determines whether or not the pitting corrosion propagation degree based on the calculation result in step S200 has reached the inspection threshold value of, namely the management target, in other words, the L1 dovetail to the L3 dovetail (step S35).

When it is not determined that the pitting corrosion propagation degree has reached the inspection threshold value of the management target (NO in step S35), the display information generator 125 generates display information based on the calculation result stored in the calculation result storage 134 and the information stored in the template storage 136 (step S36). Details are as follows.

First, at the stage of delivery of the pitting corrosion propagation degree management system 100 from its manufacturer to a customer of the power plant 1, there is a case where an initial environmental setting is performed in the manufacturer, and the table G as the alarm display is displayed on the output screen 142 of the pitting corrosion propagation degree management system 100 exemplified in FIG. 6. Alternatively, the table G as the alarm display is already displayed in some cases before the determination this time in step S35.

When, in the determination this time in step S35, it is not determined that the pitting corrosion propagation degree has reached the inspection threshold value of the management target (NO in step S35), the display information generator 125 generates display information including no display of the table G as the alarm display (step S36). Similar display information is output also when the display with no alarm display is already performed, and in this case, it is possible to employ a method in which the same display information is not output again.

Further, the display information generator 125 outputs the generated display information to the display information storage 137 and the user interface 140. The display information storage 137 houses and stores the display information. The user interface 140 displays a screen based on the generated information (step S37). After that, the processing of step S35 and thereafter is repeated.

When it is determined that the pitting corrosion propagation degree has reached the inspection threshold value of the turbine rotating part 10a (YES in step S35), the progress controller 150 outputs information regarding the date at which the pitting corrosion propagation degree has reached the inspection threshold value (information related to the inspection recommendation date) to the calculation result storage 134. Here, in the case of the graph F on the output screen 142 exemplified in FIG. 6, the curves L12 to L32 on the right side of the straight line LC indicating the present, indicating the future pitting corrosion propagation degrees change linearly in each year. Specifically, the curves L12 to L32 have a zigzag shape. The information regarding the year and the month can be obtained by calculating a value on the horizontal axis of a point at which the straight line H1 indicating the inspection threshold value and any of the curves L12 to L32 intersect at first.

The calculation result storage 134 stores this information. The display information generator 125 generates display information based on the calculation result stored in the calculation result storage 134 and the information stored in the template storage 136 (step S38). Further, the display information generator 125 outputs the generated display information to the display information storage 137 and the user interface 140. The display information storage 137 stores the display information.

The user interface 140 displays a screen including information related to the inspection recommendation date, based on the display information output from the display information generator 125 (step S39). Here, the information related to the inspection recommendation date on the screen corresponds to the table G, and the dotted line H1 indicating the inspection threshold value in the graph F on the output screen 142 in FIG. 6 illustrated as an example.

As described above, based on the procedure of the future prediction processing, the information regarding the future pitting corrosion propagation degree on the output screen 142 exemplified in FIG. 6 is updated. According to the future operation plan, the information regarding the future pitting corrosion propagation degree on the output screen 142 changes. Further, according to the future operation plan, the inspection recommendation date also changes.

With the use of the pitting corrosion propagation degree management system 100 of the present first embodiment described above, it is possible to display the pitting corrosion propagation degree from the past to the present predicted based on the operation data of the actual machine, and the future pitting corrosion propagation degree predicted based on the operation plan assumed in the future, in chronological order, in the graph F on the output screen 142 of the display part of the user interface 140. Further, as exemplified by the output screen 143, it is possible to display the past transition of values of each water quality parameter. As a result of this, the past performance and the future prediction of pitting corrosion can be visually confirmed.

Further, in the pitting corrosion propagation degree management system 100, it is possible to display the inspection threshold value in the graph F on the output screen 142. This makes it possible for a user to visually confirm the inspection recommendation date regarding the management target.

By concretely recognizing the inspection recommendation date, the user can properly perform preparations for an adjustment of a process and a workplace, securement of budget, and so on in the corresponding periodic inspection.

In the pitting corrosion propagation degree management system 100, it is possible to display the calculation result of the future pitting corrosion propagation degree based on the operation plan input on the input screen 141 of the future operation plan illustrated in FIG. 3. Accordingly, by changing the operation plan on the input screen 141 of the future operation plan, the user can visually confirm a difference in the future pitting corrosion propagation degree based on the operation plan, in the graph F on the output screen 142. Further, the user can visually confirm a difference in the inspection recommendation date based on the future operation plan, in the table G as the alarm display on the output screen 142.

### Second Embodiment

In the second embodiment, another example of information regarding a future pitting corrosion propagation degree displayed on the display part of the user interface 140 will be explained.

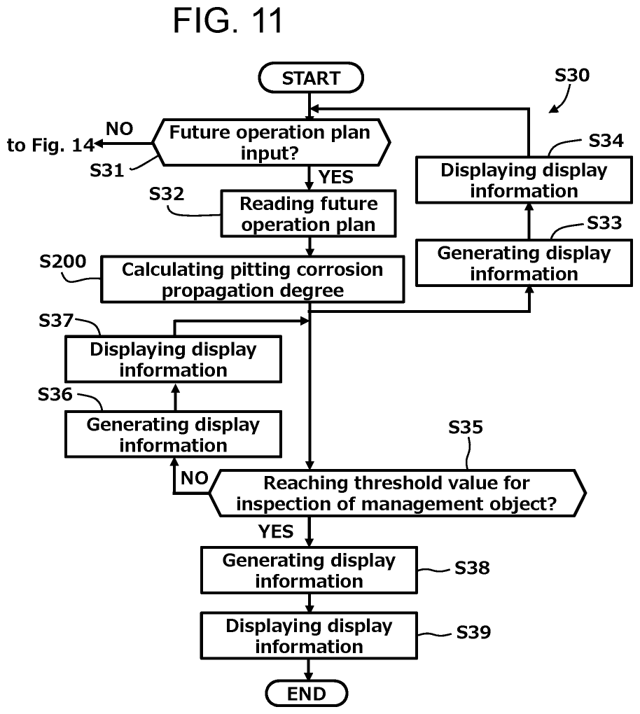

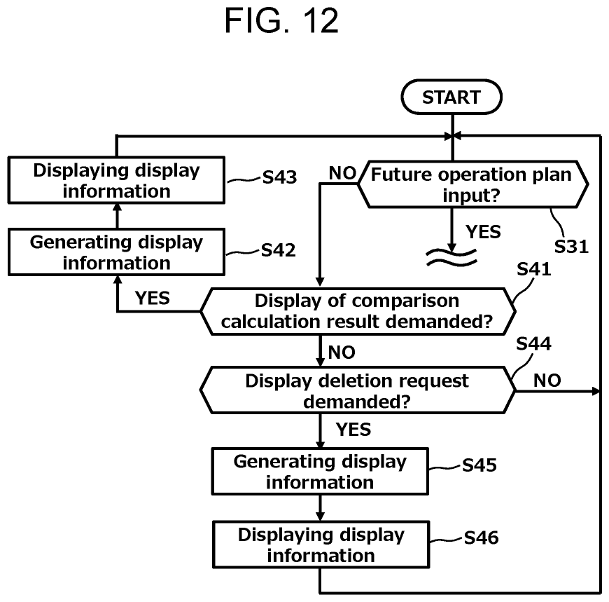

FIG. 11 and FIG. 12 are flow charts for explaining future prediction processing in the pitting corrosion propagation degree management system 100 according to the second embodiment. Note that due to the constitutional reason of the drawing, the flow chart cannot be illustrated by one chart, so that a flow chart continued from NO in step S41 in FIG. 11 will be illustrated in FIG. 12. FIG. 12 is a diagram illustrating one example of a display screen in the pitting corrosion propagation degree management system 100 according to the second embodiment. Note that in the second embodiment, parts having configurations same as those of the pitting corrosion propagation degree management system 100 of the first embodiment will be denoted by the same reference numerals, and an overlapped explanation thereof will be omitted or simplified.

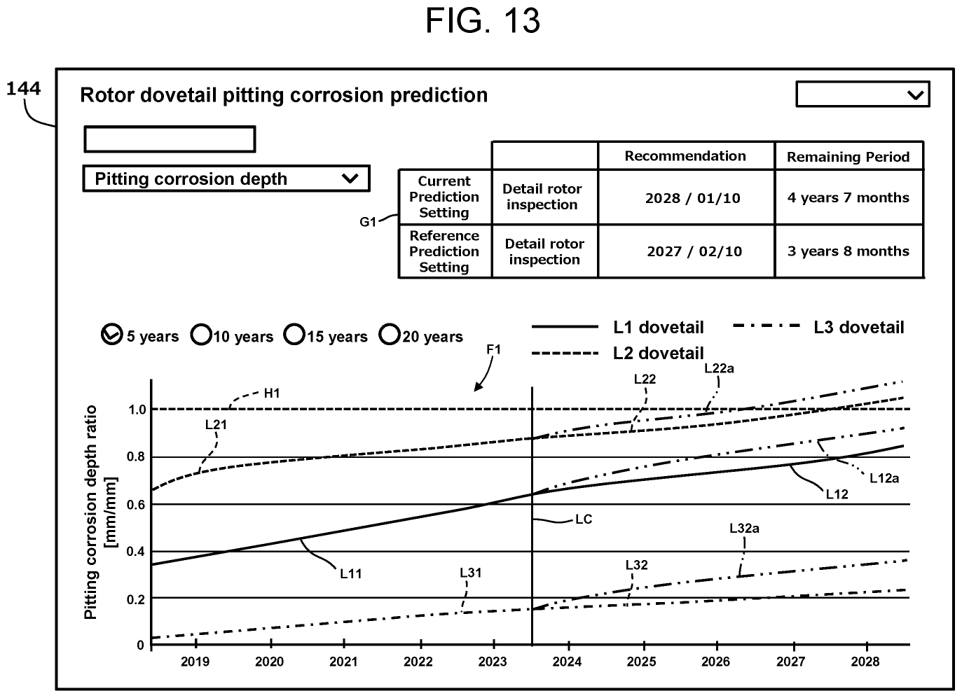

The pitting corrosion propagation degree management system 100 in the second embodiment is different from that in the first embodiment in that it is possible to simultaneously display a calculation result based on another future operation plan, on an output screen 144 (FIG. 13) indicating the calculation results of the pitting corrosion propagation degree. Here, this different configuration will be mainly explained. Note that fixed cycle calculation processing of the pitting corrosion propagation in the second embodiment is similar to the fixed cycle calculation processing in the first embodiment.

The future prediction processing in the second embodiment illustrated in FIG. 11 and FIG. 12 corresponds to the future prediction processing in the first embodiment to which processing from step S41 to step S46 is added.

Here, the user inputs the future operation plan, and then presses the selection display K of “Save” in FIG. 3. In the future prediction processing in the second embodiment, the user interface 140 receives the input from the selection display K of “Save”, and outputs the information related to the future operation plan to the input information storage 131, similarly to the future prediction processing in the first embodiment. The input information storage 131 stores the information related to the future operation plan.

Further, upon receiving the information from the user interface 140 in accordance with the pressing of the selection display K of “Save”, the progress controller 150 determines that the future operation plan has been input.

As illustrated in FIG. 11, the progress controller 150 determines whether or not the future operation plan has been input (step S31).

When, in the determination in step S31, it is determined that the future operation plan has been input (YES in step S31), the processing from step S32 to step S34 via step S200 is executed in a manner as described above. Further, after the processing of step S34, the processing of step S31 is executed again, in a manner as described above.

On the other hand, when, in the determination in step S31, it is determined that the future operation plan has not been input (NO in step S31), the display information generator 125 determines whether or not there is a display request of a result calculated based on another future operation plan (reference calculation result), as illustrated in FIG. 12 (step S41). The reference calculation result is a calculation result that is already predicted based on another future operation plan, and is stored in the calculation result storage 134. Note that the other future operation plan functions as a second future operation plan, and the reference calculation result functions as second future pitting corrosion propagation degree related information.

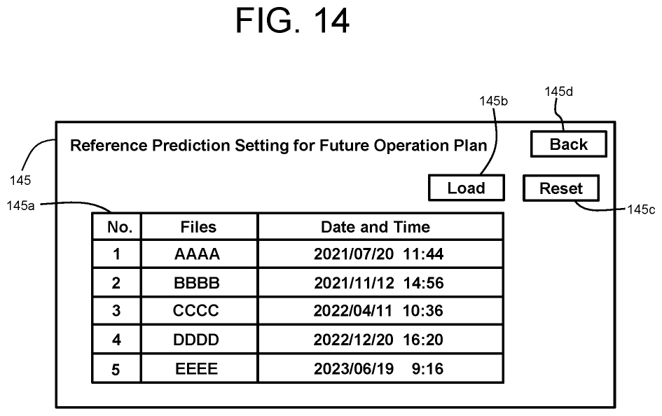

Here, FIG. 14 is a diagram illustrating one example of a selection screen 145 for selecting the reference calculation result to be displayed on the user interface 140 in the pitting corrosion propagation degree management system according to the second embodiment.

For example, by pressing the pull-down selection field H on the output screen 142 illustrated in FIG. 6, selection items such as the selection screen 145 are displayed in the pull-down selection field H, which is not illustrated though. Further, when the selection screen 145 in the selection items of the pull-down selection field H is selected, the screen of the display part of the user interface 140 is switched to the selection screen 145 illustrated in FIG. 14. At this time, the display information generator 125 inputs information related to the selection of the selection screen 145 from the user interface 140, and outputs display information for displaying the selection screen 145 to the user interface 140.

A list of calculation results that are already calculated and stored in the calculation result storage 134, is displayed at a list display part 145a on the selection screen 145 in FIG. 14. Further, here, an example of the list display part 145a that also displays date and time of storing the calculation result in the calculation result storage 134, is indicated. On the list display part 145a, for example, file names of five calculation results are displayed in chronological order of storing the calculation results in the calculation result storage 134. Note that the configuration displayed on the list display part 145a is not limited to this. The list display part 145a is only required to display a list of already-calculated calculation results.

The user selects, from the list displayed at the list display part 145a, the file name of the calculation result to be displayed in the graph F on the output screen 142 in FIG. 6, for example, as the reference calculation result. Subsequently, the user presses a Load button 145b on the selection screen 145. When the user presses the Load button 145b, the screen is switched to the output screen 142 indicating the calculation result.

Note that a BACK button 145d is a button that is pressed when returning to the output screen 142, for example, without pressing the Load button 145b or a Reset button 145c.

Upon receiving a signal based on the pressing of the Load button 145b from the user interface 140, the display information generator 125 determines that there is a display request of the reference calculation result in step S41.

When, in the determination in step S41, it is determined that there is the display request of the reference calculation result (YES in step S41), the display information generator 125 generates display information based on the calculation result stored in the calculation result storage 134 and the information stored in the template storage 136 (step S42). Here, the display information generator 125 reads both the calculation result based on the future operation plan and the selected reference calculation result stored in the calculation result storage 134. Further, the display information generator 125 outputs the generated display information to the display information storage 137 and the user interface 140. The display information storage 137 stores the display information.

The user interface 140 displays the display information output from the display information generator 125 on the display part, as illustrated in FIG. 12 (step S43). As illustrated in FIG. 13, on the output screen 144, in addition to the curves L12 to L32 as the calculation results based on the future operation plan, curves L12a to L32a each indicated by a two-dot chain line as the reference calculation result are displayed as the future pitting corrosion propagation degrees. Note that according to need, the curves L12a to L32a may also be displayed in a manner of being distinguished from one another.

Concretely, as the future pitting corrosion propagation degree, a pitting corrosion propagation degree ratio in each calculation result is indicated in chronological order. Note that the pitting corrosion propagation degree ratio in the reference calculation result is indicated by a broken line L3. Further, in a table M as an alarm display, an inspection recommendation date and a replacement recommendation date in each calculation result are displayed. Note that as illustrated in FIG. 13, the past pitting corrosion propagation degree is also indicated in chronological order.

Note that the inspection recommendation date in the reference calculation result functions as a second inspection recommendation date, and the replacement recommendation date in the reference calculation result functions as a second replacement recommendation date.

When, in the determination in step S61, it is determined that there is no display request of the reference calculation result (NO in step S41), the display information generator 125 determines whether or not there is a display deletion request of the reference calculation result (step S44).

Here, the user can delete the reference calculation result indicated on the output screen 144 in FIG. 13, by pressing the Reset button 145c on the selection screen 145 in FIG. 14. Upon receiving a signal based on the pressing of the Reset button 145c from the user interface 140, the display information generator 125 determines that there is the display deletion request of the reference calculation result in step S44. Note that when the user presses the Reset button 145c, the screen is switched to the display screen indicating the calculation result.

When, in the determination in step S44, it is determined that there is the display deletion request of the reference calculation result (YES in step S44), the display information generator 125 generates display information based on the calculation result stored in the calculation result storage 134 and the information stored in the template storage 136 (step S45). Here, the display information generator 125 reads the calculation result based on the future operation plan stored in the calculation result storage 134. Subsequently, the display information generator 125 outputs the generated display information to the display information storage 137 and the user interface 140. The display information storage 137 stores the display information.

The user interface 140 displays the display information output from the display information generator 125 on the display part, as illustrated in FIG. 12 (step S46). Specifically, the reference calculation result is deleted and only the calculation result based on the future operation plan is displayed on the output screen 142, as illustrated in FIG. 6.

When, in the determination in step S44, it is determined that there is no display deletion request of the reference calculation result (NO in step S44), the processing returns to step S31.

Further, the progress controller 150 performs the processing in step S200, and then determines whether or not the pitting corrosion propagation degree has reached a replacement threshold value based on the calculation result in step S200, in a manner as described above (step S35). Further, the processing from step S37 to step S39 is executed in a manner as described above.

The information regarding the future pitting corrosion propagation degree on the output screen 144 is updated every time the information in accordance with the pressing of the selection display K of “Save” on the input screen 141 of the future operation plan, and the Load button 145b or the Reset button 145c on the selection screen 145 of the reference calculation result is received.

Note that here, one example of selecting one calculation result as the reference calculation result is described, but it is also possible to set that a plurality of reference calculation results can be selected.

With the use of the pitting corrosion propagation degree management system 100 of the second embodiment described above, it is possible to obtain operations and effects similar to those of the pitting corrosion propagation degree management system 100 of the first embodiment.

Further, with the use of the pitting corrosion propagation degree management system 100 of the second embodiment, it is possible to display, on the output screen 144, both the calculation result predicted based on the future operation plan and the reference calculation result, as the future pitting corrosion propagation degree.

Accordingly, the user can visually confirm, in the graph F1 on the output screen 144, the difference between the pitting corrosion propagation degree in the calculation result based on the future operation plan and the pitting corrosion propagation degree in the reference calculation result. Further, the user can visually confirm, in the table G1 as the alarm display on the output screen 144, the difference between the inspection recommendation date in the calculation result based on the future operation plan and the inspection recommendation date in the reference calculation result.

As described above, according to the explained embodiments, it becomes possible to provide the pitting corrosion propagation degree management system for the rotor of the steam turbine with which it is possible to recognize, in chronological order, the pitting corrosion propagation degree from the past to the present predicted based on the measured information and the future pitting corrosion propagation degree predicted based on the future operation plan.

### Other Embodiments

Although the embodiments of the present invention have been described above, the embodiments have been presented by way of example only, and are not intended to limit the scope of the inventions. Further, the characteristics of the respective embodiments may also be combined. Furthermore, the embodiments may be embodied in a variety of other forms, and various omissions, substitutions, and changes in the form of the embodiments described herein may be made without departing from the spirit of the inventions. The accompanying claims and their equivalents are intended to cover such forms or modifications as would fall within the scope and spirit of the invention.

What is claimed is:

1. A pitting corrosion propagation degree management system for a rotor dovetail in a rotor of a steam turbine for implanting a rotor blade of the steam turbine, the system comprising
a display information generator configured to generate display information for displaying;
past pitting corrosion propagation degree related information indicating information on a past pitting corrosion propagation degree of the rotor dovetail from the past to the present calculated based on measured information; and
future pitting corrosion propagation degree related information indicating information on a future pitting corrosion propagation degree of the rotor dovetail calculated based on a future operation plan input through an input screen of a user interface and the past pitting corrosion propagation degree related information.

2. The pitting corrosion propagation degree management system for the rotor dovetail in the rotor of the steam turbine according to claim 1, wherein
the display information generator generates the display information for making both the past pitting corrosion propagation degree related information and the future pitting corrosion propagation degree related information to be displayed on the display part in chronological order.

3. The pitting corrosion propagation degree management system for the rotor dovetail in the rotor of the steam turbine according to claim 1, wherein
the display information generator generates the display information for making the past pitting corrosion propagation degree related information to be displayed on the display part, at a predetermined time interval.

4. The pitting corrosion propagation degree management system for the rotor dovetail in the rotor of the steam turbine according to claim 1, wherein
the display information generator generates the display information for making the future pitting corrosion propagation degree related information to be displayed on the display part, every time the future operation plan is input.

5. The pitting corrosion propagation degree management system for the rotor dovetail in the rotor of the steam turbine according to claim 1, wherein:
the rotor corresponds to implanting parts of blades of three stages before a final stage of a low-pressure turbine; and
the display information generator generates the display information for making information related to an inspection threshold value calculated based on the future pitting corrosion propagation degree and indicating a pitting corrosion propagation degree by which an inspection of the rotor is recommended, to be displayed on the display part.

6. The pitting corrosion propagation degree management system for the rotor dovetail in the rotor of the steam turbine according to claim 1, wherein
the display information generator generates the display information for making second pitting corrosion propagation degree related information indicating information regarding a second future pitting corrosion propagation degree of the rotor in the future calculated based on a second future operation plan input through an operation using a user interface screen and the past pitting corrosion propagation degree related information, to be further displayed on the display part.

7. The pitting corrosion propagation degree management system for the rotor dovetail in the rotor of the steam turbine according to claim 6, wherein
the display information generator generates the display information for making information related to an inspection recommendation date calculated based on a second pitting corrosion propagation degree and at which an inspection of the rotor is recommended, to be displayed on the display part.
